(19) United States
(12) Patent Application Publication
(10) Pub. No.: US 2025/0231508 A1
(43) Pub. Date: Jul. 17, 2025

(54) FIXING DEVICE AND IMAGE FORMING APPARATUS

(71) Applicant: FUJIFILM Business Innovation Corp., Tokyo (JP)

(72) Inventors: Sodai HIGUCHI, Kanagawa (JP); Takashi MATSUBARA, Kanagawa (JP); Takashi OHASHI, Kanagawa (JP); Takuma ISHIHARA, Kanagawa (JP); Hina SAITO, Kanagawa (JP)

(73) Assignee: FUJIFILM Business Innovation Corp., Tokyo (JP)

(21) Appl. No.: 18/764,160

(22) Filed: Jul. 4, 2024

(30) Foreign Application Priority Data
Jan. 11, 2024 (JP) 2024-002504

(51) Int. Cl. G03G 15/20

(52) U.S. Cl. CPC G03G 15/2053; G03G 15/2064; G03G 2215/2016

(57) ABSTRACT

A fixing device includes an endless belt that is heated and movable in a circulating manner, a fixing unit that is fixed in contact with an inner peripheral surface of the belt, a pressure roller that presses the belt against the fixing unit to form a fixing portion through which a recording material on which an unfixed image is formed is to pass and is rotationally driven, and a support roller that is disposed on an upstream side of the fixing unit in a moving direction of the belt and supports the belt to allow the belt to be rotatable, in which the fixing unit includes a first curved surface that is an arc-shaped curved surface formed on an upstream side of a position at which the fixing portion is formed in the moving direction and a second curved surface that is an arc-shaped curved surface formed on an upstream side of the first curved surface in the moving direction, and satisfies a condition of “r1>r2” in a case where a curvature radius of the first curved surface is denoted by r1 (mm) and a curvature radius of the second curved surface is denoted by r2 (mm), and the belt is spanned over the support roller and the first curved surface in a state where tension is applied to the belt.

### CROSS-REFERENCE TO RELATED APPLICATIONS

This application is based on and claims priority under 35 USC 119 from Japanese Patent Application No. 2024-002504 filed Jan. 11, 2024.

### BACKGROUND

### (i) Technical Field

The present invention relates to a fixing device and an image forming apparatus.

### (ii) Related Art

JP2014-182256A discloses a fixing device in which a contact portion of a fixing member where a belt and a pressure roller are in contact with each other is formed of an arc-shaped curved surface curved toward a side away from the pressure roller in a case where a fixing portion is formed, an insertion portion adjacent to the contact portion on an insertion side where a recording material is inserted is formed of an arc-shaped curved surface curved toward a side opposite to the contact portion, and a condition of “t(1/r1+1/r2)≤0.130 and r1≤r2” is satisfied in a case where a thickness of the belt is t (mm), a curvature radius of a curved surface of an entrance portion is r1 (mm), and a curvature radius of the curved surface of the contact portion is r2 (mm).

### SUMMARY

There is a fixing device that includes a fixing unit fixed on an inner peripheral side of an endless belt movable in a circulating manner and fixes an unfixed toner image formed on a recording material by a pressure roller which is rotated while applying pressure to the fixing unit. In this fixing device, the unfixed toner image is disturbed in a case where the posture of the belt is disturbed. A technique for providing a support roller that is in contact with the belt and rotates on the upstream side of the fixing unit to correct the posture of the belt is employed to suppress this disturbance.

However, in a case where the degree of freedom of the posture of the belt is limited due to a reason such as a short distance from the support roller to the fixing unit, the fixing unit is displaced due to vibration or the like and friction is likely to occur between an end portion of the fixing unit and the belt. For this reason, the belt is likely to be worn.

Aspects of non-limiting embodiments of the present disclosure relate to a fixing device and an image forming apparatus that suppresses wear of a belt in a case where a posture of the belt is corrected by a support roller provided on an upstream side of a fixing unit.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present invention, there is provided a fixing device including: an endless belt that is heated and movable in a circulating manner; a fixing unit that is fixed in contact with an inner peripheral surface of the belt; a pressure roller that presses the belt against the fixing unit to form a fixing portion through which a recording material on which an unfixed image is formed is to pass and is rotationally driven; and a support roller that is disposed on an upstream side of the fixing unit in a moving direction of the belt and supports the belt to allow the belt to be rotatable, in which the fixing unit includes a first curved surface that is an arc-shaped curved surface formed on an upstream side of a position at which the fixing portion is formed in the moving direction and a second curved surface that is an arc-shaped curved surface formed on an upstream side of the first curved surface in the moving direction, and satisfies a condition of “r1>r2” in a case where a curvature radius of the first curved surface is denoted by r1 (mm) and a curvature radius of the second curved surface is denoted by r2 (mm), and the belt is spanned over the support roller and the first curved surface in a state where tension is applied to the belt.

### BRIEF DESCRIPTION OF THE DRAWINGS

Exemplary embodiment(s) of the present invention will be described in detail based on the following figures, wherein:

FIG. 1 is a diagram showing an image forming apparatus to which a present exemplary embodiment is applied;

FIG. 2 is a diagram showing a configuration of a fixing device;

FIG. 3 is a diagram showing a shape of a contact member;

FIG. 4 is a diagram showing a state where a fixing belt is pressed against a fixing unit by a pressure roller; and

FIG. 5 is a diagram showing a comparative example.

### DETAILED DESCRIPTION

### Image Forming Apparatus 1

An image forming apparatus to which the present exemplary embodiment is applied will be described in detail below with reference to the accompanying drawings.

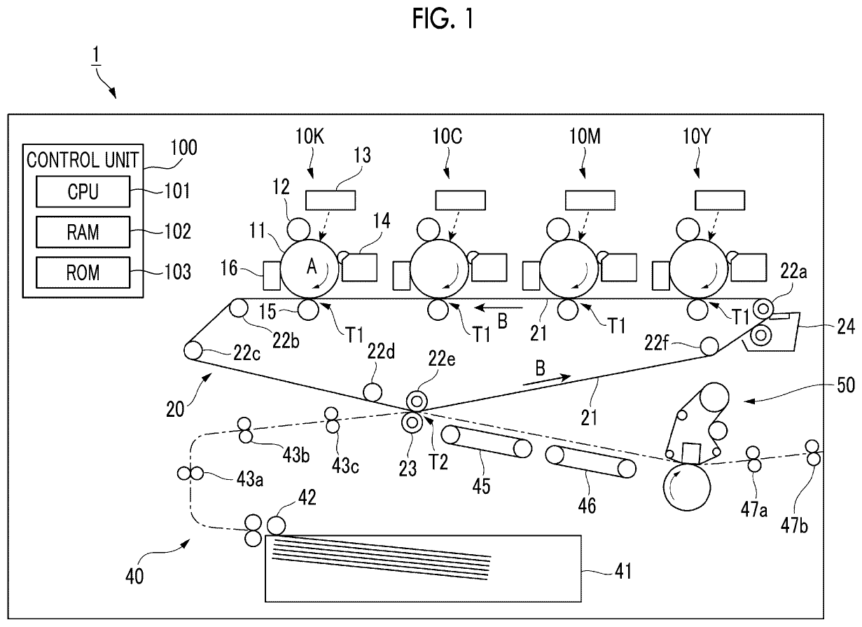

FIG. 1 is a view showing an image forming apparatus 1 according to the present exemplary embodiment.

For example, an electrophotographic image forming apparatus that forms a toner image on a recording material is exemplified as the image forming apparatus 1.

The image forming apparatus 1 includes image forming sections 10Y, 10M, 10C, and 10K (hereinafter, may be simply referred to as “image forming sections 10”) that form toner images, a transfer unit 20 that transfers the toner images formed by the image forming sections 10 onto a recording material, a transport section 40 that transports the recording material, a fixing device 50 that fixes unfixed toner images, which are unfixed images, to the recording material, and a control unit 100 that controls each part of the image forming apparatus 1.

### Control Unit 100

The control unit 100 includes a central processing unit (CPU) 101 that controls the entire image forming apparatus 1, a random access memory (RAM) 102 that is used as a work area in calculation, and a read only memory (ROM) 103 that is a memory storing various programs to be executed by the CPU 101, various settings, and the like.

### Image Forming Section 10

A plurality of image forming sections 10 shown in FIG. 1 are provided to form toner images for respective colors. In the present exemplary embodiment, image forming sections 10 for a total of four colors, that is, yellow (Y), magenta (M), cyan (C), and black (K) are provided. 10Y, 10M, 10C, and 10K shown in FIG. 1 indicate components corresponding to the respective colors. Since the image forming sections 10 for the respective colors have the same configuration except for toner to be used, the respective parts of the image forming section 10K are denoted by reference numerals in FIG. 1 as a representative of the image forming sections 10 for the respective colors.

The image forming section 10 for each color includes a photoreceptor drum 11 on which an electrostatic latent image is to be formed while being rotated in a clockwise direction in FIG. 1 (a direction of an arrow A). Further, the image forming section 10 for each color includes a charging unit 12 that charges a surface of the photoreceptor drum 11, an exposure device 13 that forms an electrostatic latent image on the photoreceptor drum 11, a developing device 14 that develops the electrostatic latent image formed on the photoreceptor drum 11, a primary transfer roller 15 that transfers a toner image formed on the photoreceptor drum 11 onto an intermediate transfer belt 21, and a drum cleaner 16 that removes developer remaining on the photoreceptor drum 11. Then, a primary transfer electric field is applied between the primary transfer roller 15 and the photoreceptor drum 11, so that the toner image formed on the photoreceptor drum 11 is transferred onto the intermediate transfer belt 21 at a primary transfer position T1.

### Transfer Unit 20

The transfer unit 20 includes an intermediate transfer belt 21 onto which a toner image for each color formed on the photoreceptor drum 11 of each image forming section 10 is to be transferred, and belt support rollers 22a to 22f that are provided on an inner peripheral side of the intermediate transfer belt 21. Further, the transfer unit 20 includes a secondary transfer roller 23 that collectively transfers the toner images transferred onto the intermediate transfer belt 21 onto the recording material. Furthermore, the transfer unit 20 includes a cleaner 24 that removes toner or the like remaining on the surface of the intermediate transfer belt 21.

The toner image is transferred onto an outer peripheral surface of the intermediate transfer belt 21 from the photoreceptor drum 11 for each color. As shown in FIG. 1, the intermediate transfer belt 21 has an endless shape and is wound around the plurality of belt support rollers 22a to 22f. At least one of the plurality of belt support rollers 22a to 22f is rotationally driven, so that the intermediate transfer belt 21 is rotated in a direction of an arrow B.

The secondary transfer roller 23 is disposed to face the belt support roller 22e with the intermediate transfer belt 21 interposed therebetween. The secondary transfer roller 23 presses the intermediate transfer belt 21 against the belt support roller 22e and is rotated.

As shown in FIG. 1, the cleaner 24 is disposed on an outer peripheral side of the intermediate transfer belt 21. The cleaner 24 is disposed on a downstream side of the secondary transfer roller 23 and on an upstream side of the image forming section 10 in the rotation direction of the intermediate transfer belt 21.

### Transport Section 40

The transport section 40 includes a storage unit 41 that stores recording materials and a sending device 42 that sends out the recording materials stored in the storage unit 41 one by one. Further, the transport section 40 includes pairs of sheet transport rollers 43a to 43c that transport the recording material from the storage unit 41 to a secondary transfer position T2 of the transfer unit 20. Furthermore, the transport section 40 includes sheet transport belts 45 and 46 that transport the recording material from the secondary transfer position T2 to the fixing device 50. Moreover, the transport section 40 includes pairs of sheet discharge rollers 47a and 47b for discharging the recording material, which is sent from the fixing device 50, to the outside of the image forming apparatus 1.

### Fixing Device 50

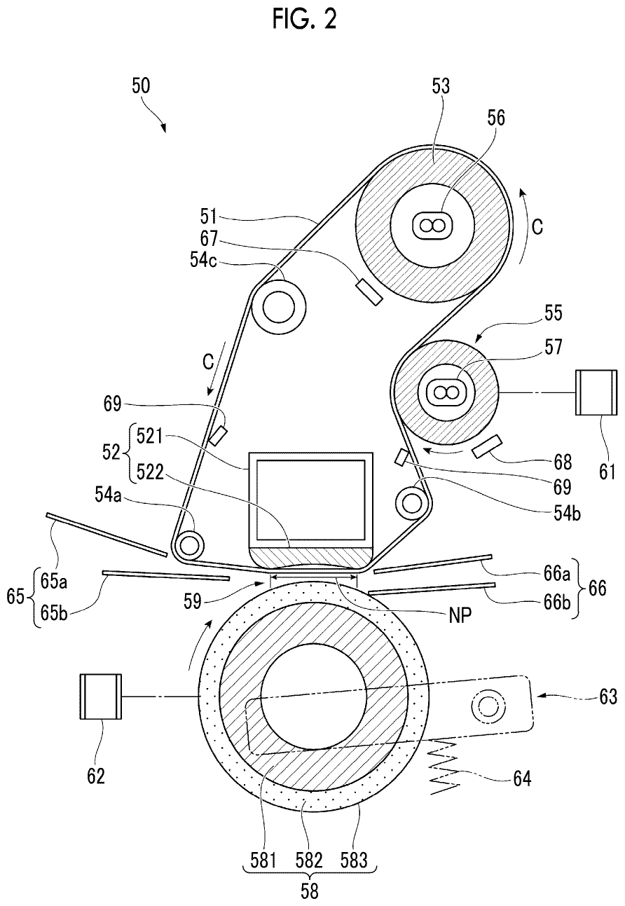

The fixing device 50 to which the present exemplary embodiment is applied will be described below with reference to FIG. 2.

FIG. 2 is a diagram showing a configuration of the fixing device 50.

The fixing device 50 includes a fixing belt 51 which is an endless belt that is heated and movable in a circulating manner, a fixing unit 52 that is fixed in contact with an inner peripheral surface of the fixing belt 51, internal support rollers 53 and 54a to 54c that are provided in contact with the inner peripheral surface of the fixing belt 51 and support the fixing belt 51 to allow the fixing belt 51 to be rotatable, and an external support roller 55 that is provided in contact with an outer peripheral surface of the fixing belt 51 and supports the fixing belt 51 to allow the fixing belt 51 to be rotatable. Further, the fixing device 50 includes a pressure roller 58 that is provided at a position facing the fixing unit 52, a displacement mechanism 63 that displaces a position of the pressure roller 58, and a pressure mechanism 64 that applies a force for pressing toward the fixing unit 52 to the pressure roller 58. Furthermore, the fixing device 50 includes an application device 69 that applies a lubricant to the inner peripheral surface of the fixing belt 51, introduction guide members 65a and 65b that guide the recording material to the fixing device 50, and discharge guide members 66a and 66b that guide the recording material to which the toner images are fixed by the fixing device 50 to a transport path.

The fixing belt 51 is formed of a plurality of layers, and is formed of three layers in the present exemplary embodiment. In the present exemplary embodiment, the fixing belt 51 includes, for example, a substrate of an endless belt, an elastic layer that is formed on a surface (outer peripheral surface) side of the substrate, and a release layer that is formed on the elastic layer. The substrate is made of, for example, a material such as a polyimide resin. Further, the elastic layer is formed of, for example, an elastic member, such as silicone rubber. Furthermore, the release layer is made of, for example, a material such as a tetrafluoroethylene-perfluoroalkyl vinyl ether copolymer (PFA).

In addition, the width of the fixing belt 51 is set to a dimension larger than the maximum value of the width in a case where the recording material is transported. Further, the length of the fixing belt 51 is set to a dimension required for the fixing belt 51 to be wound around the fixing unit 52, the plurality of internal support rollers 53 and 54a to 54c, and the external support roller 55.

The fixing unit 52 includes a rectangular tubular support 521 that is disposed in a fixed state, and a contact member 522 that is in contact with the inner peripheral surface of the fixing belt 51.

The support 521 is disposed such that a longitudinal direction thereof (a direction in which a rectangular tube extends) which is a direction orthogonal to the transport direction of the recording material is from the front side to the rear side of the device. Further, the support 521 is provided to face the pressure roller 58. The support 521 is made of, for example, a metal such as iron or aluminum, or a material such as a liquid crystal polymer.

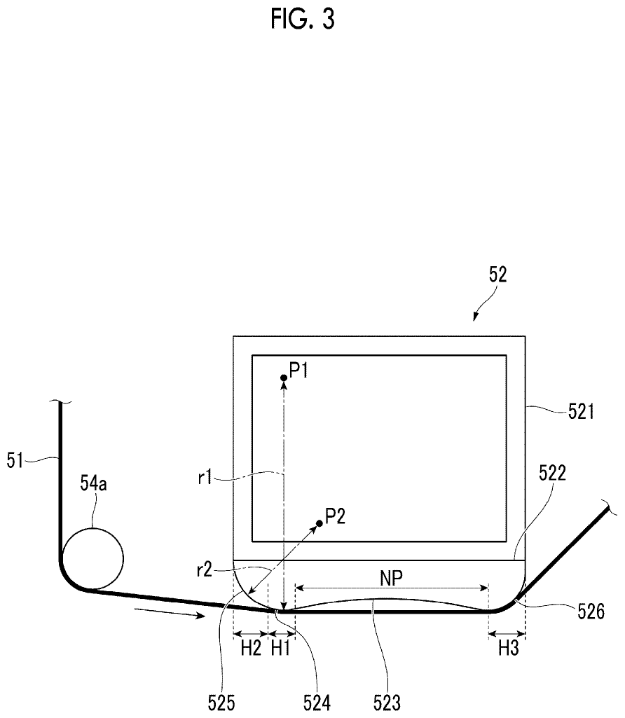

The contact member 522 is mounted on a surface of the support 521 facing the pressure roller 58. Furthermore, the contact member 522 is made of, for example, a fluororesin material such as polytetrafluoroethylene (PTFE) or perfluoroalkoxy (PFA). The shape of the contact member 522 will be described later with reference to FIG. 3.

The internal support roller 53 is a cylindrical roller made of aluminum or the like, and is disposed at a position farthest from the fixing unit 52 in a rotatable state. Further, a halogen heater 56 is provided in an inner space of the internal support roller 53. The internal support roller 53 is heated by the halogen heater 56, so that the internal support roller 53 heats the fixing belt 51 from an inner peripheral surface side of the fixing belt 51. Furthermore, the internal support roller 53 is provided with a temperature detector 67 that detects the surface temperature of the internal support roller 53. In addition, since the internal support roller 53 supports the fixing belt 51 in a state where the internal support roller 53 elastically presses the fixing belt 51 from the inner peripheral surface side of the fixing belt 51 toward an outer peripheral surface side thereof, the internal support roller 53 is also formed as a tension applying roller that applies tension to the fixing belt 51.

The internal support roller 54a is disposed on an upstream side of the fixing unit 52 in a moving direction of the fixing belt 51 (a direction of an arrow C), and supports the fixing belt 51 to allow the fixing belt 51 to be rotatable. The internal support roller 54a corrects the posture of the fixing belt 51 that is not yet in contact with the fixing unit 52.

The internal support roller 54b is disposed on a downstream side of the fixing unit 52 in the moving direction of the fixing belt 51, and supports the fixing belt 51 to allow the fixing belt 51 to be rotatable. The internal support roller 54b corrects the posture of the fixing belt 51 separated from the fixing unit 52.

The internal support roller 54c is disposed between the internal support roller 53 and the internal support roller 54a in a rotatable state in the moving direction of the fixing belt 51. The internal support roller 54c corrects the posture of the fixing belt 51 during the running.

The external support roller 55 is a cylindrical roller made of aluminum or the like, and is disposed in contact with the outer peripheral surface of the fixing belt 51 and in a rotatable state. The external support roller 55 is provided between the internal support roller 54b and the internal support roller 53 in the moving direction of the fixing belt 51. A halogen heater 57 is provided in an inner space of the external support roller 55. The external support roller 55 is heated by the halogen heater 57, so that the external support roller 55 heats the fixing belt 51 from the outer peripheral surface side. Further, the external support roller 55 is provided with a temperature detector 68 that detects a surface temperature of the external support roller 55. Furthermore, the external support roller 55 is provided with a first drive unit 61 that is formed of a drive motor or the like. The first drive unit 61 is adapted to be capable of rotationally driving the external support roller 55 at a necessary timing. Accordingly, the external support roller 55 rotationally drives the fixing belt 51 in the direction of the arrow C.

The pressure roller 58 is disposed along the rear side from the front side of the image forming apparatus 1 such that a longitudinal direction of a rotating shaft of the pressure roller 58 is a direction orthogonal to the transport direction of the recording material. The pressure roller 58 is a roller having a structure in which an elastic layer 582 made of silicone rubber or the like and a release layer 583 made of PFA or the like are sequentially laminated on an outer peripheral surface of a cylindrical roller substrate 581 made of aluminum or the like. The elastic layer 582 is a layer that is elastically deformed in a case where the pressure roller 58 presses the fixing belt 51 against the fixing unit 52 to form a fixing region NP. For example, the hardness of the elastic layer 582 is set to a value satisfying a relationship in which the hardness of the elastic layer 582 is higher than the hardness of the fixing unit 52. Here, the fixing region NP is a region in which the pressure roller 58 presses the fixing belt 51 against the fixing unit 52, and is denoted by reference numeral NP in FIG. 2. A fixing portion 59 through which the recording material on which unfixed images are formed is to pass is formed in this fixing region NP.

The pressure roller 58 includes a second drive unit 62 that rotates the pressure roller 58, and the pressure roller 58 is rotationally driven. The second drive unit 62 is formed of a drive motor or the like. Accordingly, the pressure roller 58 is in contact with the outer peripheral surface of the fixing belt 51 pressed against the fixing unit 52 and is rotationally driven, so that the pressure roller 58 rotates the fixing belt 51 in a direction indicated by the arrow C.

The displacement mechanism 63 moves the pressure roller 58 to a first position where the pressure roller 58 is in contact with the fixing unit 52 and a second position where the pressure roller 58 is separated from the fixing unit 52. A state where the pressure roller 58 is at the second position is shown in FIG. 2. For example, a mechanism that is adapted to displace a support frame, which supports the pressure roller 58 to allow the pressure roller 58 to be rotatable, with a displacement drive element, such as a cam is used as the displacement mechanism 63.

The pressure mechanism 64 applies a force toward the fixing unit 52 to the pressure roller 58. A mechanism formed using a spring member and the like is applied as the pressure mechanism 64, and the pressure mechanism 64 is adapted to function in combination with the displacement mechanism 63.

The introduction guide members 65 are provided at a position near the upstream side of the fixing region NP in the transport direction of the recording material. The introduction guide members 65 guide the recording material toward an entrance of the fixing region NP.

The discharge guide members 66 are provided at a position near the downstream side of the fixing region NP in the transport direction of the recording material. The discharge guide members 66 guide the recording material, to which the toner images have been fixed, toward the pair of sheet discharge rollers 47a (see FIG. 1). The discharge guide member 66b, which is disposed closer to the pressure roller 58, of the discharge guide members 66 is provided in a state where a tapered peeling claw (not shown) for peeling off the recording material, which is discharged from the fixing region NP, from an outer peripheral surface of the pressure roller 58 is lightly in contact with the outer peripheral surface of the pressure roller 58. Further, the discharge guide member 66b is mounted a frame or the like of the displacement mechanism 63 and is adapted to be displaced in conjunction with the displacement operation of the displacement mechanism 63.

### Contact Member 522

Next, a shape of the contact member 522 to which the present exemplary embodiment is applied will be described with reference to FIG. 3.

FIG. 3 is a diagram showing the shape of the contact member 522 that is in contact with the inner peripheral surface of the fixing belt 51.

A contact surface 523, with which the fixing belt 51 pressed by the pressure roller 58 (see FIG. 2) is in contact, is formed on the contact member 522 in a range indicated by the fixing region NP shown in FIG. 3. Further, a large-diameter surface 524 over which the fixing belt 51 from the internal support roller 54a is spanned is formed on the contact member 522 in a range indicated by H1 shown in FIG. 3. Furthermore, a small-diameter surface 525 that avoids contact with the fixing belt 51 is formed on the contact member 522 in a range indicated by H2 shown in FIG. 3. In addition, a downstream-side surface 526, which has a so-called R shape to reduce friction applied to the fixing belt 51 separated from the contact member 522, is formed on the contact member 522 in a range indicated by H3 shown in FIG. 3. The large-diameter surface 524 formed in the range indicated by H1 is an example of a first curved surface, and the small-diameter surface 525 formed in the range indicated by H2 is an example of a second curved surface.

The contact surface 523 is a concave portion that is curved in a direction away from the pressure roller 58 and is an arc-shaped surface. The contact surface 523 is designed such that the magnitude of the curvature of the arc thereof is substantially equal to the magnitude of the curvature of the outer diameter of the pressure roller 58. Accordingly, the fixing region NP in which the pressure roller 58 presses the fixing belt 51 has a width of the contact surface 523 in the transport direction of the recording material.

The large-diameter surface 524 is continuous with the contact surface 523 in the moving direction of the fixing belt 51 and is formed on the upstream side of the contact surface 523. The large-diameter surface 524 is a convex portion that protrudes toward the fixing belt 51 and is an arc-shaped curved surface. A center of the arc of the large-diameter surface 524 is shown as a point P1 in FIG. 3. Further, a curvature radius of the arc of the large-diameter surface 524 is shown in FIG. 3 as r1 (mm).

The large-diameter surface 524 is provided such that any of tangents thereto is in contact with the outer diameter of the internal support roller 54a. Accordingly, the fixing belt 51 is spanned over the large-diameter surface 524 from the internal support roller 54a in a state where tension is applied to the fixing belt 51.

The small-diameter surface 525 is formed on the upstream side of the large-diameter surface 524 in the moving direction of the fixing belt 51. The small-diameter surface 525 is a convex portion that protrudes toward the fixing belt 51 and is an arc-shaped curved surface. A center of the arc of the small-diameter surface 525 is shown as a point P2 in FIG. 3. Further, a curvature radius of the arc of the small-diameter surface 525 is shown as r2 (mm) in FIG. 3.

The curvature radius r2 of the small-diameter surface 525 is formed to satisfy a condition of “r1>r2”.

Furthermore, in the present exemplary embodiment, the magnitude of the curvature radius r2 of the small-diameter surface 525 may be set to be larger than a curvature radius at which the fixing belt 51 starts to deteriorate in a case where the fixing belt 51 is curved. Here, the deterioration of the fixing belt 51 is an irreversible change occurring in a case where the fixing belt 51 is curved, and is, for example, a crack that occurs in a polyimide resin used for the substrate of the fixing belt 51. The curvature radius at which the fixing belt 51 starts to deteriorate varies depending on various conditions such as a material used for the fixing belt 51 and an environment in which the fixing belt 51 is used, and the curvature radius at which the fixing belt 51 starts to deteriorate is determined using experiments, simulations, or the like.

Further, in the present exemplary embodiment, the magnitude of the curvature radius r2 may be determined as the magnitude of a curvature radius at which the fixing belt 51 does not come into contact with the small-diameter surface 525 even in a case where the fixing belt 51 is fluttering. For example, in a case where the curvature radius r2 of the small-diameter surface 525 is large, the fixing belt 51 that is in contact with the large-diameter surface 524 is likely to come into contact with the small-diameter surface 525 in a case where the fixing belt 51 is fluttering. Therefore, the magnitude of the curvature radius r2 is determined as a value smaller than the value at which the fixing belt 51 does not come into contact with the small-diameter surface 525. Here, the fluttering of the fixing belt 51 is the disturbance of the fixing belt 51 that occurs in a case where the fixing belt 51 is moved in a circulating manner, and is, for example, a state where the fixing belt 51 is wavy.

Furthermore, in the present exemplary embodiment, the large-diameter surface 524 and the small-diameter surface 525 are formed at an end portion of the fixing unit 52, and the large-diameter surface 524 is formed to be continuous with the small-diameter surface 525. The large-diameter surface 524 does not have to be continuous with the small-diameter surface 525, and for example, a flat surface or a curved surface may be formed between the large-diameter surface 524 and the small-diameter surface 525.

In addition, in the present exemplary embodiment, the large-diameter surface 524 and the small-diameter surface 525 are smoothly continuous. Here, “smoothly continuous” means that one tangent is determined at a boundary between the large-diameter surface 524 and the small-diameter surface 525. The large-diameter surface 524 and the small-diameter surface 525 may be angular without being smoothly continuous.

The downstream-side surface 526 is formed at an end portion of the contact member 522 on the downstream side of the contact surface 523 in the moving direction of the fixing belt 51.

### Treatment Performed by Fixing Device 50

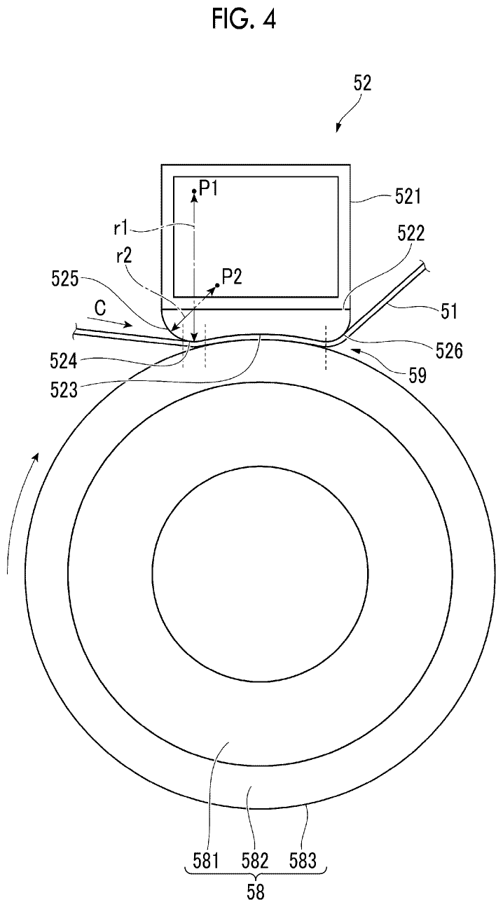

Next, an action of the fixing device 50 according to the present exemplary embodiment will be described with reference to FIGS. 2 and 4.

FIG. 4 is a diagram showing a state where the fixing belt 51 is pressed against the fixing unit 52 by the pressure roller 58. The pressure roller 58 presses the fixing belt 51 against the contact surface 523 of the contact member 522 and is rotated clockwise in FIG. 4.

In a case where a main power source of the image forming apparatus 1 (see FIG. 1) is turned on, the fixing device 50 (see FIG. 1) according to the present exemplary embodiment is also supplied with necessary power accordingly and starts a warm-up operation.

In the warm-up operation of the fixing device 50, first, the displacement mechanism 63 operates to separate the pressure roller 58 from the fixing belt 51 and the halogen heaters 56 and 57 operate to heat the internal support roller 53 and the external support roller 55. In a case where it is determined that surface temperatures of the halogen heaters 56 and 57 are equal to or higher than a predetermined temperature, the displacement mechanism 63 moves the pressure roller 58 to the position where the pressure roller 58 is pressed against the fixing unit 52 and the first drive unit 61 and the second drive unit 62 are rotationally driven, respectively. Accordingly, the fixing belt 51 is moved in a circulating manner and is heated over the entire circumference of the fixing belt 51.

During fixing, in the fixing device 50, as shown in FIG. 4, the pressure roller 58 is in a state where the pressure roller 58 presses the fixing belt 51 against the fixing unit 52 to form the fixing portion 59. In this case, the elastic layer 582 of the pressure roller 58 is elastically deformed in a state where a portion of the fixing belt being in contact with the fixing unit 52 and passing by is bitten. Further, in the fixing device 50, rotational power is transmitted to the fixing belt 51 from the pressure roller 58, which is in contact with the outer peripheral surface of the fixing belt 51, and the fixing belt 51 is rotated in the direction indicated by the arrow C. In this case, the external support roller 55 is freely rotatable without being rotationally driven, and rotates following the fixing belt 51. For this reason, during a fixing operation, the fixing belt 51 receives only the rotational power of the pressure roller 58 and is rotated in the direction indicated by the arrow C at a required speed.

In this case, the recording material on which unfixed toner images are formed is guided to the lower introduction guide member 65b and passes through the fixing region NP between the fixing belt 51 and the pressure roller 58. When the recording material passes through the fixing region NP, the recording material is subjected to heating treatment and pressurization treatment, so that the unfixed toner images are fixed to the recording material. The recording material on which the fixing has been completed is peeled off from the pressure roller 58 by the discharge guide member 66 and is discharged from the fixing device 50.

In the present exemplary embodiment, as described above, the large-diameter surface 524 over which the fixing belt 51 is spanned is formed on the contact member 522 and the small-diameter surface 525 is formed on the upstream side of the large-diameter surface 524 in the moving direction of the fixing belt 51. Accordingly, since the fixing belt 51 is pressed by the large-diameter surface 524 having a larger curvature radius r1 in a case where the fixing unit 52 is displaced, the bending of the fixing belt 51 is suppressed as compared to a case where a curvature radius at a position where the fixing belt 51 is spanned over is small. Therefore, even in a case where the fixing unit 52 is displaced, the contact between the fixing belt 51 and the fixing unit 52 is suppressed on the upstream side of the large-diameter surface 524.

Further, in the present exemplary embodiment, since the magnitude of the curvature radius r2 of the small-diameter surface 525 is larger than a curvature radius at which the fixing belt 51 starts to deteriorate in a case where the fixing belt 51 is curved, the deterioration of the fixing belt 51 caused by curvature is suppressed even in a case where the fixing belt 51 is in contact with the small-diameter surface 525.

### Comparative Example

Here, a case where the contact member 522 of the fixing unit 52 does not include the large-diameter surface 524 will be described as a comparative example.

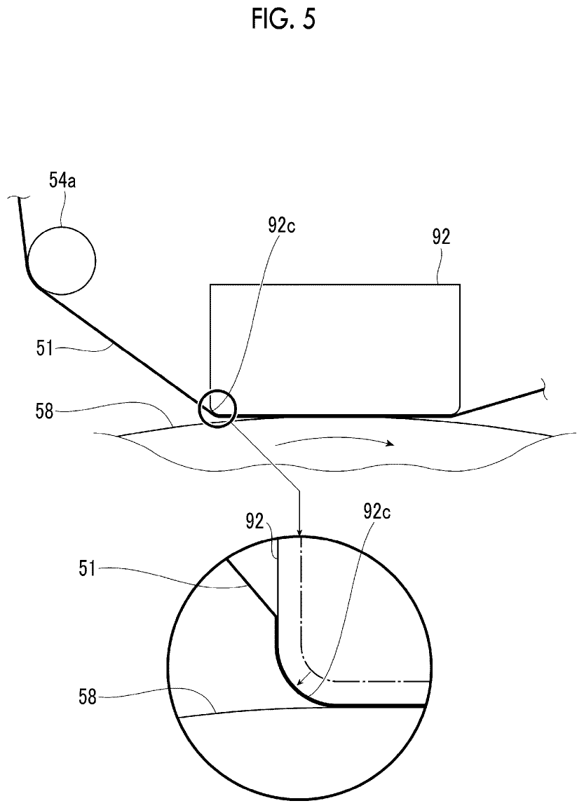

FIG. 5 is a diagram showing the comparative example.

A fixing unit 92 corresponding to the fixing unit 52 of the present exemplary embodiment is shown in this comparative example. The fixing unit 92 does not include a portion corresponding to the large-diameter surface 524 unlike the fixing unit 52 of the present exemplary embodiment.

FIG. 5 shows a state of the pressure roller 58 in a case where a fixing operation is performed, and the pressure roller 58 presses the fixing belt 51 against the fixing unit 92 and is rotated clockwise in FIG. 5. The fixing unit 92 includes a rounded corner portion 92c having a so-called R shape at an upstream end portion thereof in the moving direction of the fixing belt 51. In this comparative example, the fixing belt 51 is spanned over the internal support roller 54a and the rounded corner portion 92c. In a case where the fixing belt 51 is moved, friction occurs between the inner peripheral surface of the fixing belt 51 and the rounded corner portion 92c.

In an enlarged view of FIG. 5, a position of the fixing unit 92 not yet displaced is shown by a one-dot chain line and a state where the fixing unit 92 has been displaced due to an influence of the vibration of the image forming apparatus or the like is shown by a solid line. After the fixing unit 92 is displaced, an inner peripheral side of the fixing belt 51 is in contact with even the side surface of the fixing unit 92 along the rounded corner portion 92c. In a case where the rounded corner portion 92c is displaced, the fixing belt 51 is more likely to be bent along the rounded corner portion 92c as the curvature of the rounded corner portion 92c is smaller. Further, a crack or the like may occur in the fixing belt 51 as the fixing belt 51 is bent along the rounded corner portion 92c. This crack causes the deterioration of the fixing belt 51. Furthermore, in a case where the fixing belt 51 is moved in a circulating manner while being in contact with the side surface of the fixing unit 92, friction occurs between the side surface of the fixing unit 92 and the fixing belt 51, which may cause wear of the fixing belt 51.

With regard to the shape of the contact member 522 of the fixing device 50 to which the present exemplary embodiment is applied As described above, the small-diameter surface 525 is provided at the upstream end portion of the fixing unit 52 in the moving direction of the fixing belt 51 and the large-diameter surface 524 is provided on the downstream side of the small-diameter surface 525 to be continuous with the small-diameter surface 525. Further, the fixing belt 51 is spanned over the large-diameter surface 524. For this reason, in the fixing device 50 to which the present exemplary embodiment is applied, in a case where the fixing unit 52 is displaced, the arc-shaped large-diameter surface 524 having a large curvature radius r1 presses the fixing belt 51, and the bending of the fixing belt 51 is suppressed as compared to a case where the fixing belt 51 is spanned over a curved surface having a small curvature radius. As a result, wear of the fixing belt 51 is suppressed.

### Supplementary Note

(((1)))

A fixing device comprising:
an endless belt that is heated and movable in a circulating manner;
a fixing unit that is fixed in contact with an inner peripheral surface of the belt;
a pressure roller that presses the belt against the fixing unit to form a fixing portion through which a recording material on which an unfixed image is formed is to pass and is rotationally driven; and
a support roller that is disposed on an upstream side of the fixing unit in a moving direction of the belt and supports the belt to allow the belt to be rotatable,
wherein the fixing unit includes a first curved surface that is an arc-shaped curved surface formed on an upstream side of a position at which the fixing portion is formed in the moving direction and a second curved surface that is an arc-shaped curved surface formed on an upstream side of the first curved surface in the moving direction, and satisfies a condition of “r1>r2” in a case where a curvature radius of the first curved surface is denoted by r1 (mm) and a curvature radius of the second curved surface is denoted by r2 (mm), and
the belt is spanned over the support roller and the first curved surface in a state where tension is applied to the belt.
   (((2)))

The fixing device according to (((1))),
wherein the first curved surface and the second curved surface are formed at an end portion of the fixing unit, and
the second curved surface is formed to be continuous with the first curved surface.
   (((3)))

The fixing device according to (((2))),
wherein the first curved surface and the second curved surface are smoothly continuous.
   (((4)))

The fixing device according to any one of (((1))) to (((3))),
wherein the curvature radius of the second curved surface is larger than a curvature radius at which the belt starts to deteriorate in a case where the belt is curved.
   (((5)))

The fixing device according to any one of (((1))) to (((4))),
wherein the curvature radius of the second curved surface is determined as a curvature radius at which the belt does not come into contact with the second curved surface even in a case where the belt is fluttering.
   (((6)))

An image forming apparatus comprising:
an image forming unit that forms an unfixed image on a recording material; and
the fixing device according to any one of (((1))) to (((5))) that fixes the unfixed image formed by the image forming unit to the recording material.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
an endless belt that is heated and movable in a circulating manner;
a fixing unit that is fixed in contact with an inner peripheral surface of the belt;
a pressure roller that presses the belt against the fixing unit to form a fixing portion through which a recording material on which an unfixed image is formed is to pass and is rotationally driven; and
a support roller that is disposed on an upstream side of the fixing unit in a moving direction of the belt and supports the belt to allow the belt to be rotatable,
wherein the fixing unit includes a first curved surface that is an arc-shaped curved surface formed on an upstream side of a position at which the fixing portion is formed in the moving direction and a second curved surface that is an arc-shaped curved surface formed on an upstream side of the first curved surface in the moving direction, and satisfies a condition of “r1>r2” in a case where a curvature radius of the first curved surface is denoted by r1 (mm) and a curvature radius of the second curved surface is denoted by r2 (mm), and
the belt is spanned over the support roller and the first curved surface in a state where tension is applied to the belt.

2. The fixing device according to claim 1,
wherein the first curved surface and the second curved surface are formed at an end portion of the fixing unit, and
the second curved surface is formed to be continuous with the first curved surface.

3. The fixing device according to claim 2,
wherein the first curved surface and the second curved surface are smoothly continuous.

4. The fixing device according to claim 1,
wherein the curvature radius of the second curved surface is larger than a curvature radius at which the belt starts to deteriorate in a case where the belt is curved.

5. The fixing device according to claim 4,
wherein the curvature radius of the second curved surface is determined as a curvature radius at which the belt does not come into contact with the second curved surface even in a case where the belt is fluttering.

6. An image forming apparatus comprising:
an image forming unit that forms an unfixed image on a recording material; and
the fixing device according to claim 1 that fixes the unfixed image formed by the image forming unit to the recording material.

7. An image forming apparatus comprising:
an image forming unit that forms an unfixed image on a recording material; and
the fixing device according to claim 2 that fixes the unfixed image formed by the image forming unit to the recording material.

8. An image forming apparatus comprising:
an image forming unit that forms an unfixed image on a recording material; and
the fixing device according to claim 3 that fixes the unfixed image formed by the image forming unit to the recording material.

9. An image forming apparatus comprising:
an image forming unit that forms an unfixed image on a recording material; and
the fixing device according to claim 4 that fixes the unfixed image formed by the image forming unit to the recording material.

10. An image forming apparatus comprising:
an image forming unit that forms an unfixed image on a recording material; and
the fixing device according to claim 5 that fixes the unfixed image formed by the image forming unit to the recording material.
